(19) United States
(12) Patent Application Publication
(10) Pub. No.: US 2015/0124358 A1
(43) Pub. Date: May 7, 2015

(54) FEEDER POWER SOURCE PROVIDING OPEN FEEDER DETECTION FOR A NETWORK PROTECTOR BY SHIFTED NEUTRAL

(71) Applicant: EATON CORPORATION, CLEVELAND, OH (US)

(72) Inventor: ROBERT EUGENE HULSE, WAYNE, ME (US)

(73) Assignee: EATON CORPORATION, CLEVELAND, OH (US)

(21) Appl. No.: 14/070,175

(22) Filed: Nov. 1, 2013

(51) Int. Cl. H02H 3/16; H02H 7/22

(52) U.S. Cl. CPC H02H 3/165; H02H 7/22
USPC 361/47

(57) ABSTRACT

A feeder power source for a network power system includes a network transformer having a delta three-phase primary winding and a three-phase secondary winding; a three-phase primary feeder electrically connected to the delta three-phase primary winding; a three-phase secondary bus electrically connected to the three-phase secondary winding; and a three-phase electrical switching apparatus structured to open and close the three-phase primary feeder. A network protector includes a network relay and a three-phase circuit breaker structured to open and close the three-phase secondary bus. A first circuit is electrically connected between at least one phase of the three-phase primary feeder and ground, and is structured to unbalance shunt impedance to the three-phase primary feeder ground. A second circuit detects a shift in system neutral and detects that the three-phase primary feeder is opened by the three-phase electrical switching apparatus.

### BACKGROUND

1. Field

The disclosed concept pertains generally to network power systems and, more particularly, to feeder power sources for such systems.

2. Background Information

Low voltage secondary power distribution networks consist of interlaced loops or grids supplied by two or more sources of power, in order that the loss of any one source will not result in an interruption of power. Such networks provide the highest possible level of reliability with conventional power distribution and are, normally, used to supply high-density load areas, such as a section of a city, a large building or an industrial site.

Each power source supplying the network is typically a medium voltage feeder including a switch, a voltage reducing transformer and a network protector. As is well-known, a network protector is an apparatus used to control the flow of electrical power to a distribution network. The network protector includes a low voltage circuit breaker and a control relay which opens the circuit to the transformer upon detection of abnormal current flow. Specifically, the control relay typically senses the network voltages, the line currents and the phasing voltage, and executes algorithms to initiate circuit breaker tripping or re-closing actions. Trip determination is based on detecting reverse power flow, that is, power flow from the network to the primary feeder. Examples of network protector relays are disclosed in U.S. Pat. Nos. 3,947,728; 5,822,165; 5,844,781; and 6,504,693, which are incorporated by reference herein.

Network protectors are required to open when a feeder supplying the network transformer primary is opened. A known method to detect an open feeder is reverse current flow through the network protector. The magnitude of reverse current that will flow depends upon many factors and can range from a relatively small value due to magnetizing a single transformer, to a relatively much larger value that could include back feeding an entire feeder circuit. Setting a reverse current detector to account for all of the potential conditions is problematic under many situations. Such reverse current detection presents an even greater challenge when feeders from separate power sources are used to power a common network bus or grid due to the circulating power that can result during normal operation. When the reverse current threshold is set high enough to tolerate the maximum circulating current and to not impact system operation, it is likely that smaller reverse current levels that can result when a primary feeder of limited size is opened will not be detected.

It is known to detect single line-to-ground faults on ungrounded or high impedance grounded power systems.

There is room for improvement in feeder power sources.

### SUMMARY

These needs and others are met by embodiments of the disclosed concept which unbalance shunt impedance to ground of a three-phase primary feeder, and detect a shift in system neutral of that primary feeder when a three-phase feeder power source is isolated from that primary feeder by the opening of a three-phase electrical switching apparatus.

In accordance with the disclosed concept, a feeder power source for a network system comprises: a network transformer including a delta three-phase primary winding and a three-phase secondary winding; a three-phase primary feeder electrically connected to the delta three-phase primary winding; a three-phase secondary bus electrically connected to the three-phase secondary winding; a three-phase electrical switching apparatus structured to open and close the three-phase primary feeder; a network protector including a network relay and a three-phase circuit breaker structured to open and close the three-phase secondary bus; a first circuit electrically connected between at least one phase of the three-phase primary feeder and ground, the first circuit being structured to unbalance shunt impedance to the ground of the three-phase primary feeder; and a second circuit structured to detect a shift in system neutral and detect that the three-phase primary feeder is opened by the three-phase electrical switching apparatus.

### BRIEF DESCRIPTION OF THE DRAWINGS

A full understanding of the disclosed concept can be gained from the following description of the preferred embodiments when read in conjunction with the accompanying drawings in which:

FIG. 1 is a circuit diagram in schematic form of a single-phase capacitor bank applied to a feeder power source to create a detectable neutral shift in accordance with embodiments of the disclosed concept.

FIG. 2 is a circuit diagram in block form of a circuit to detect the neutral shift of the feeder power source of FIG. 1.

FIG. 3 is a circuit diagram in schematic form of a circuit representing interconnected sequence networks for finding the zero-sequence voltage on a primary feeder during back feed in the absence of a fault and employing the capacitor bank of FIG. 1.

FIGS. 4 and 5 are plots of primary feeder zero-sequence voltage in per unit of line-to-neutral voltage versus feeder equivalent length, for three sizes of the capacitor bank of FIG. 1.

FIG. 6 is a plot of primary feeder zero-sequence voltage in per unit of line-to-neutral voltage versus feeder equivalent length, for three sizes of the network transformer of FIG. 1.

FIG. 7 is a circuit diagram in schematic form of a three-phase capacitor bank in which a number of the capacitors are larger than the other capacitor(s) to create a detectable neutral shift in accordance with another embodiment of the disclosed concept.

FIG. 8 is a circuit diagram in schematic form of a capacitor bank in which two equal capacitors are applied to only two of three phases to create a detectable neutral shift in accordance with another embodiment of the disclosed concept.

### DESCRIPTION OF THE PREFERRED EMBODIMENTS

As employed herein, the term “number” shall mean one or an integer greater than one (i.e., a plurality).

As employed herein, the term “processor” shall mean a programmable analog and/or digital device that can store, retrieve, and process data; a computer; a workstation; a personal computer; a controller; a digital signal processor; a microprocessor; a microcontroller; a microcomputer; a central processing unit; a mainframe computer; a mini-computer; a server; a networked processor; or any suitable processing device or apparatus.

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

The disclosed concept takes advantage of the fact that the vast majority of primary feeder power sources are effectively grounded (i.e., there is a substantially low impedance between the supply system neutral and ground such that the system neutral is held very close to ground potential and the zero-sequence voltage is nearly zero; application of single (or unbalanced) capacitor(s) when the system is effectively grounded will have no effect on the system neutral-to-ground voltage), and the primary windings of the vast majority of network transformers are configured as delta. This power source topology results in the primary feeder circuit undergoing a transition from effectively grounded, to ungrounded, when a feeder supply electrical switching apparatus, such as a switch or circuit breaker, is opened. In a typical three-phase power system, the primary component of shunt impedance to ground is capacitance associated with feeder three-phase cables, and other system component insulation. This capacitance tends to be relatively balanced such that there is relatively little shift in the system voltage relative to ground (i.e., a neutral shift) when the system becomes ungrounded. By unbalancing the system shunt impedance to ground on the three phases, the transition from grounded to ungrounded will result in a detectable shift in the system neutral that can be used as the basis for detecting the open feeder.

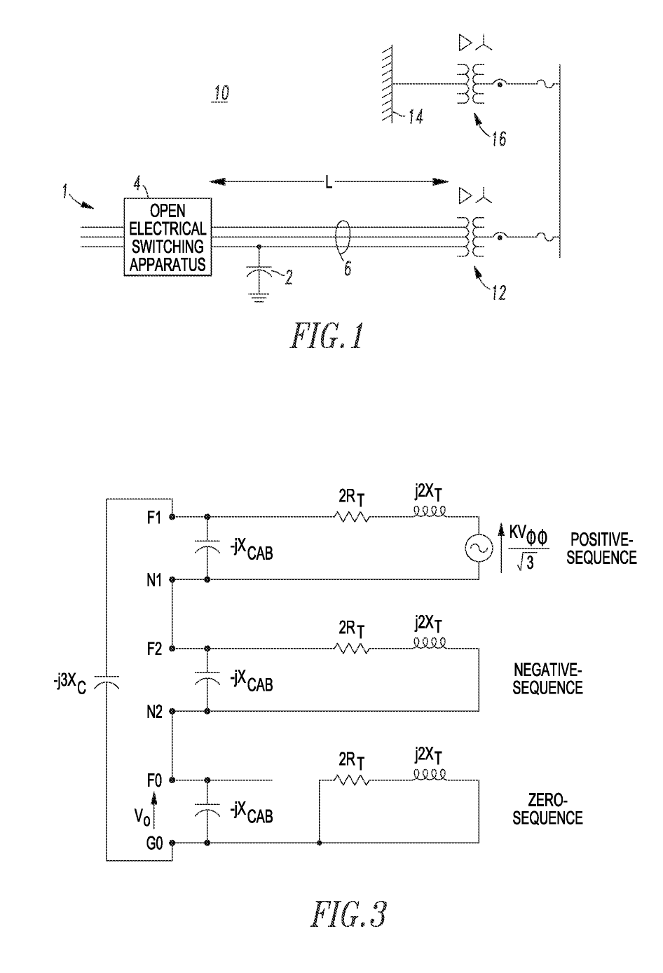

The disclosed concept, which makes use of this phenomenon, can include, for example and without limitation, a relatively small three-phase capacitor bank 20 (FIG. 7), a two-phase capacitor bank 34 (FIG. 8), or a single-phase capacitor bank, such as a number of capacitors 2 (FIG. 1). The example three-phase, two-phase, or single-phase capacitor banks disclosed herein can be combined with fuses (e.g., without limitation, fuses 78 of FIG. 7) and/or other active and/or passive elements (not shown) (e.g., without limitation, resistors) connected line-to-ground. In the example three-phase capacitor bank 20 (FIG. 7), for example, one capacitor can be larger than the other two capacitors, in order that a detectable neutral shift is assured when the system ground reference is removed. The example fuses and other elements provide a level of security for the power system in the event of component failure, and enhance the performance of the disclosed concept based on specific application conditions.

The neutral shifting elements are applied in conjunction with a suitable measuring circuit for the three phase-to-ground voltages in order to allow reliable discrimination between the grounded system (feeder closed) and the ungrounded system (feeder open). A wide range of measuring circuits are known to persons of ordinary skill in the art and include potential transformers and a wide variety of voltage division circuits. The measured system neutral relative to ground is then monitored by a suitable relay or processor-based device, with suitable sensitivity and adjustment to reliably detect the open feeder and cause a network protector to open independent of the need to detect reverse current flow.

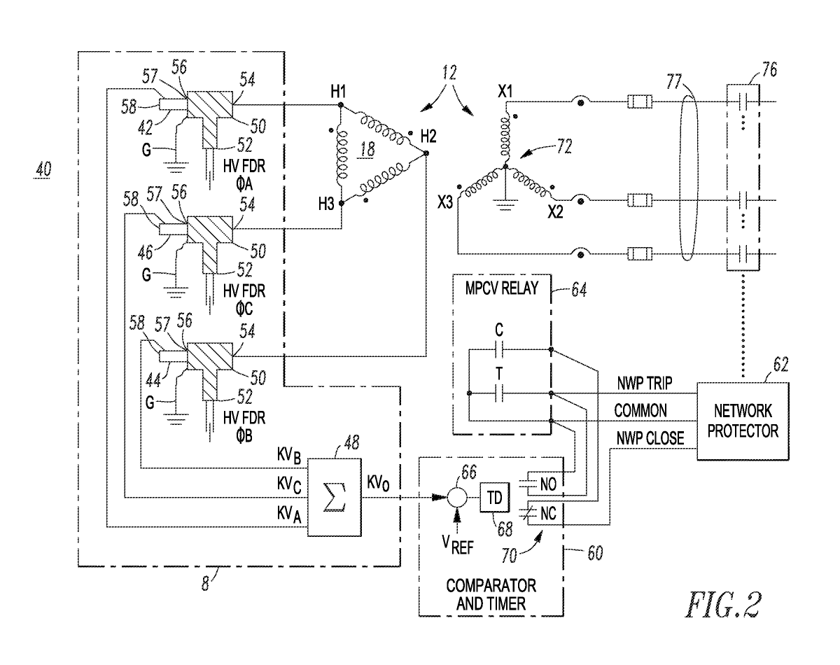

FIG. 1 shows an example single-phase capacitor bank (e.g., a number of capacitors 2) for inducing an unbalance in phase-to-ground impedance and creating a detectable neutral shift for a feeder power source 1. When a source feeder electrical switching apparatus, such as circuit breaker 4, is opened, the number of capacitors 2 impose a shift of the system neutral on the feeder side (i.e., the right side (with respect to FIG. 1) of open circuit breaker 4; shown as three-phase primary feeder 6) by unbalancing the phase-to-ground impedances among the three feeder phases of three-phase primary feeder 6. The neutral shift does not occur on the source side (i.e., the left side (with respect to FIG. 1) of the open circuit breaker 4). The condition of the source (grounded or ungrounded) does not change when the circuit breaker 4 is opened. The feeder circuit does not include a neutral conductor. Instead, the neutral is a derived point. When the system shunt impedance is balanced, the neutral point is at the geometric center of a line-to-line voltage triangle (not shown). This enables an example voltage measurement circuit 8, such as shown in FIG. 2, to practically detect the resulting shift (neutral shift) in phase-to-ground voltages among the three feeder phases, and detect an open feeder through measurement of the three phase-to-ground voltages. The example number of capacitors 2 deliberately impose unbalanced line-to-ground impedances, in order to permit the reliable detection of the example open feeder circuit breaker 4, which is normally operated from a suitably low-impedance grounded source bus (e.g., without limitation, from a wye-connected winding of a substation transformer (not shown); typically, the lower voltage, secondary side of that transformer; the neutral connection of the substation supply transformer would usually be directly connected to ground or sometimes be connected to ground through a suitably low impedance device, such as a resistor or inductor), because of the transition from grounded to ungrounded that results from the opening of the example feeder circuit breaker 4.

The number of capacitors 2 applied from phase-to-ground on the primary feeder has an impedance, which is the capacitive reactance of the number of capacitors 2, X_{C} ohms. Assuming that the primary terminals H1,H2,H3 (shown in FIG. 2) of the network transformer 12 of the energized feeder in FIG. 1 is supplied from an infinite bus (see infinite bus 14 as shown with another network transformer 16 of network power system 10) having a phase-to-phase voltage equal to the rated voltage of the network transformer delta winding 18 (FIG. 2), then the zero-sequence voltage on the feeder whose circuit breaker 4 is open can be found from an analysis of interconnected sequence networks shown in FIG. 3.

For example and without limitation, the example single-phase capacitor 2 can be 50, 100 or 150 kVAr rated at 13.8 kV, and the three-phase primary feeder 6 can be of length L (kilo-feet) at 13.2 kV with a 35 kVAr per mile or 50 kVAr per mile three-phase charging capacitance.

Application of, for example and without limitation, the single-phase number of capacitors 2 of FIG. 1 imposes the system neutral shift, which lowers the phase-to-ground impedance on the corresponding feeder phase when the three-phase feeder circuit breaker 4 is open. Alternatively, other suitable circuits to impose such a neutral shift include, but are not limited to, the capacitor bank 20 (FIG. 7) in which various capacitors 22,24,26 in combination are applied on all three respective phases 28,30,32 to ground; a capacitor bank 34 (FIG. 8) in which two equal capacitors 36,38 are applied to only two 28,30, respectively, of the three phases 28,30,32; a passive impedance circuit (not shown) including resistors, inductors and capacitors applied alone or in some combination on one, two or three phases to achieve a suitable neutral shift; and an active circuit (not shown) capable of acting on the system phase-to-ground impedance when the feeder is open to create a neutral shift.

FIG. 2 shows an example circuit 40 to detect the neutral shift. This is just one of many potential circuits to detect the neutral shift. The example circuit 40 employs three resistance voltage dividers 42,44,46, for example and without limitation, marketed by Lindsey Manufacturing Co. of Azusa, Calif., as measurement devices for outputting representative phase-to-ground voltages KV_{A},KV_{B},KV_{C} and a summation circuit 48 that outputs a resultant zero-sequence voltage KV₀ (K is the ratio of the resistance voltage divider and V₀ is the actual primary feeder zero-sequence voltage) that increases as the system neutral shift is increased. Each of the resistance voltage dividers 42,44,46 is coupled, for example and without limitation, to an elbow connector 50. The resistance voltage dividers 42,44,46, the circuit 8 and the comparator/timer 60 are located at or about the network transformer 12. Although example elbow connectors 50 are shown, other suitable types of transformer bushing connectors and cable connectors can be employed with the same or different voltage measurement circuits. The example elbow connector 50 has a first terminal 52 for a corresponding one of the three phase voltages, a second terminal 54 for a corresponding terminal H1,H2,H3 of the delta winding 18 of the network transformer 12, and a third terminal 56 for the input 57 of the corresponding one of the resistance voltage dividers 42,44,46. For example, each of the resistance voltage dividers 42,44,46 includes two resistors (not shown) in series, a smaller resistor (Rs) and a larger resistor (Rl), electrically connected from phase (at terminal 52 and input 57) to ground G with resistor Rs between ground G and a voltage measuring tap 58, and resistor Rl between the output of voltage measuring tap 58 and the phase voltage (at terminal 52 and input 57). The two resistors Rl,Rs then split the line-to-ground voltage according to the Rs/(Rs+Rl) ratio K such that the voltage (Vm) between the voltage measuring tap 58 and ground G is equal to the system line-to-ground voltage (e.g., without limitation, 13.2 kV) times the Rs/(Rs+Rl) ratio K, thereby providing a sensed voltage KV_{A},KV_{B},KV_{C} having a suitably low and safe value. A comparator/timer 60 monitors measured voltage KV₀ against a suitable threshold V_{REF} to provide a control output to open network protector 62 when a shift beyond the threshold V_{REF} is detected for a suitable time delay TD.

Other suitable circuits for sensing the phase-to-ground voltages include, but are not limited to, custom resistive or capacitive voltage dividers, potential transformers, and Hall effect or other active devices.

The example MPCV relay 64 is the network relay (e.g., main control relay) of the network protector 62 that automatically opens or closes the network protector circuit breaker 76 based on system conditions. The example MPCV relay 64 uses reverse current flow to attempt to detect an open feeder and cause the network protector circuit breaker 76 to trip open. The problem with this approach is that many system conditions can have an effect on the amount of reverse current that the MPCV relay 64 will experience, thereby making it difficult to set the MPCV relay 64 to detect an open feeder under all conditions. By imposing a neutral shift and responding to the voltage shift rather than (or preferably in addition to) reverse current makes open feeder detection much more reliable under a wider range of conditions. The example open feeder detection circuit 40 has contacts NO in parallel with the trip contact T of the MPCV relay 64 in order to trip open the network protector circuit breaker 76 with the NWP TRIP signal as referenced to the COMMON. Preferably, as shown, there is also a contact NC in series with the MPCV close contact C, in order to block the MPCV relay 64 from reclosing the network protector circuit breaker 76 with the NWP CLOSE signal. Although a discrete circuit including the summation circuit 48, the voltage reference V_{REF}, a comparator 66, a time delay 68 and relays 70,64 are disclosed, any suitable circuit including a processor can be employed. Also, the voltage reference V_{REF} and the comparator 66 need not be an actual signal and an actual comparison circuit. Instead, these could be, for example, a threshold value and a logical “if greater than” operation.

Although the comparator/timer 60 is applied to a conventional network protector 62 using control relay 64, it will be appreciated that the functionality of the relay 70 contacts and/or the circuits 8 and/or 60 can be integrated with the control relay 64.

Alternatively, in place of the summation circuit 48 and the comparator/timer 60, a direct comparison of KV_{A} to KV_{B} to KV_{C} and a threshold to determine the extent of neutral shift due to an open feeder can be employed. The example summation circuit 48 does a phasor summation of the three phase-to-ground voltages using both magnitude and angle to output the zero-sequence voltage KV₀, which is then compared to the zero-sequence threshold V_{REF}. Alternatively, each phase-to-ground voltage can be compared directly to each other phase-to-ground voltage in magnitude only to detect the neutral shift without the need to consider the angles. For example, if the capacitor 2 was applied to phase A, then the magnitude KV_{A} would be smaller than the magnitudes of KV_{B} and KV_{C} when the circuit breaker 4 is open.

The primary winding 18 of the network transformer 12 is delta in order that no network transformer on the load side of an open feeder circuit breaker, such as 4, can act as a balanced phase-to-ground low impedance and thereby prevent the neutral shift. Any suitable secondary winding 72 of the network transformer 12 can be employed, although the example wye connection is believed to be most common in network transformers.

The example circuit 40 of FIG. 2 detects a back feed to a single line-to-ground fault on the network primary feeder when the back feed current is below the non-sensitive trip setting of the network protector MPCV relay 64. The non-sensitive trip setting is selected to allow operation of two-unit spot networks from primary feeders having widely differing voltages, both in magnitude and angle.

The three phase-to-ground voltages of the primary feeder are summed by the summation circuit 48, in order to provide the signal KV₀ proportional to the zero-sequence component V₀ of the primary feeder line-to-ground voltages. If the measured zero-sequence voltage KV₀ is above a suitable threshold, shown as V_{REF} in FIG. 2, and persists for a time greater than a predetermined time delay TD for the trip signal, then the network protector 62 is tripped and locked open as long as the measured zero-sequence voltage KV₀ remains above the threshold level V_{REF}.

With a bolted single line-to-ground fault on the primary feeder with the feeder circuit breaker 4 (FIG. 1) open, the zero-sequence voltage, in per unit of the primary system nominal phase-to-ground voltage (e.g., without limitation, 13.2 kV), would be approximately 1.0 per unit. In the absence of a fault with the primary feeder circuit breaker 4 closed, the zero-sequence voltage V₀ is not expected to exceed about 1% to about 2% (about 0.01 to about 0.02 per unit) of nominal phase-to-ground voltage. Hence, the difference in zero-sequence voltage between an un-faulted condition and with a single line-to-ground fault is substantial, thereby allowing positive detection of the single line-to-ground fault with the primary feeder circuit breaker 4 being open.

The circuit 40 of FIG. 2 will not detect an open primary feeder circuit breaker 4 (FIG. 1) in the absence of a fault. The reason for this is that the capacitances to ground of the primary feeders and the equipment electrically connected to them, mostly due to the delta-connected primary winding 18 of the network transformers, such as 12 or 16, are nearly perfectly balanced. With the feeder circuit breaker 4 open in the absence of a fault, the zero-sequence voltage V₀ of the feeder would not change enough from that with the circuit breaker 4 closed for the circuit 40 of FIG. 2 to detect the open feeder circuit breaker 4.

The disclosed power factor capacitor 2 (FIG. 1), which is electrically connected from one phase to ground on the primary feeder, generates sufficient zero-sequence voltage V₀ on the primary feeder in order to allow detecting a back feed in the absence of a fault with the circuit 40 of FIG. 2.

When the primary winding 18 of all network transformers, such as 12, on the primary feeder are electrically connected in delta, and the primary feeder circuit breaker 4 is opened in the absence of a fault, the phase-to-phase voltages will stay balanced, or nearly balanced. Their magnitude will stay near nominal unless the primary three-phase cable charging current is relatively high in relation to the rated current of the back feeding transformer 12, and the stiffness of the secondary network system at the back feed location. This also applies even with a reasonably sized capacitor 2 electrically connected from phase-to-ground on one phase as in FIG. 1. However, with the capacitor 2 electrically connected from one phase to ground, the phase-to-ground voltages will develop a zero-sequence component. The larger the capacitor (kVAr rating) in relation to the three-phase cable charging kVAr at rated voltage, the higher the zero-sequence voltage during back feed with an open feeder circuit breaker 4.

In FIG. 3, R_{T} and X_{T} are the resistance and reactance, respectively, of each network transformer, such as 12 (FIG. 1), in ohms referred to the primary side. Capacitive reactance X_{CAB} is the capacitive reactance in ohms representing all of the primary feeder cable being energized during the back feed. Here, it is assumed that the Ferranti effect is negligible such the voltage-to-ground on any phase of the three-phase primary feeder 6 is the same throughout the primary cable system. Capacitive reactance X_{CAB} is found from the cable three-phase charging kVAr per mile at the network transformer rated voltage, and the total length L (FIG. 1) of the primary cable being back fed.

Capacitive reactance X_{C} is for the example single-phase power factor capacitor 2 (FIG. 1) connected from phase-to-ground on the primary feeder 6. This capacitor 2 needs only one medium-voltage bushing (not shown), but if equipped with two medium-voltage bushings, a current transformer (not shown) could be put into the lead to ground to monitor continuity when energized. The voltage rating of the capacitor 2 equals or exceeds the maximum phase-to-phase voltage occurring during back feed, as the capacitor 2 could be energized for a relatively long time should a network protector, such as 62 (FIG. 2), fail to open its circuit breaker 76 (FIG. 2) during back feed to a single line-to-ground fault on a phase other than that where the capacitor 2 is electrically connected. A three-phase secondary bus 77 electrically connects the network protector circuit breaker 76 to the three-phase secondary winding 72 (FIG. 2). As a non-limiting example, the capacitor 2 is rated for 13.8 kV between its terminals, and the rated phase-to-phase voltage of the primary system is 13.2 kV. The working voltage may be 125% of rated voltage.

If the capacitor rated voltage is the same as or greater than the nominal phase-to-phase voltage of the network transformer primary winding 18 (FIG. 2) (system phase-to-phase voltage), the kVAr supplied by the capacitor 2 (FIG. 1) would be one third of its nameplate rating under normal, un-faulted conditions. The voltage applied to it would be 57.7% of the capacitor rated voltage, and its kVAr output will be 33.3% of its nameplate kVAr. Thus, the capacitor 2 would not be stressed at its rated voltage, and would be expected to have a long life.

For feeders with relatively long lengths of primary cable (main and all taps), the three-phase charging kVAr could be relatively higher, in which case capacitors larger than 150 kVAr may be employed. In such situations, two single-phase capacitors (not shown) may be electrically connected in parallel to the same phase, rather than a larger capacitor, such as 2 (FIG. 1). This allows the use of a relatively smaller CL fuse (not shown) with each capacitor, and better coordination with the feeder ground relays (not shown).

However, if the capacitor 2 (FIG. 1) were shorted, then it would cause a feeder lockout, which is not acceptable, especially in systems designed for a single contingency. As a result, the capacitor 2 is preferably electrically connected to the primary feeder through a current-limiting (CL) fuse (not shown, but see the CL fuses 78 of FIG. 7), selected such that the fuse let through current will not pick-up the ground instantaneous relay (not shown) of the feeder circuit breaker 4 (FIG. 1), and such that the CL fuse will coordinate selectively with the time overcurrent ground relay (not shown) for the primary feeder. The example CL capacitor fuse, such as 78, needs to operate faster than the overcurrent protection of the feeder that normally supplies power to the network. In the event of a failure of the capacitor 2 while the feeder circuit breaker 4 is closed, in a mode that converts the intended high impedance to a low impedance (or short circuit), it is desirable to isolate the capacitor 2 from the energized power circuit rather than causing the feeder to trip. When the feeder circuit breaker 4 is open, and the feeder is being energized from the primary winding 18 of the network transformer 12, there is no zero-sequence source (since the network transformer primary winding 18 is delta) and hence even a very low impedance (or short circuit) fault will pass no current and cause no harm.

By applying the example capacitor 2 (FIG. 1) from phase-to-ground on a single phase, a neutral shift for the system results when the feeder circuit breaker 4 is open.

The capacitor 2 (FIG. 1) is suitably sized in order that the change in zero-sequence voltage V₀ occurring when the feeder circuit breaker 4 (FIG. 1) is opened in absence of a fault will be such that the circuit 40 of FIG. 2, or any suitable alternative circuit, will detect the open feeder circuit breaker 4. The amount of zero-sequence voltage V₀ needed to reliably detect the open feeder circuit breaker 4, in the absence of a fault, is a function of the accuracy of the voltage measurement circuit 8 (e.g., without limitation, as shown in FIG. 2).

Typical network feeders operate in the 15 kV voltage class, such as for example and without limitation, 11 kV, 12.47 kV, 13.2 kV and 13.8 kV. The following assumes a system with a nominal phase-to-phase voltage of 13.2 kV.

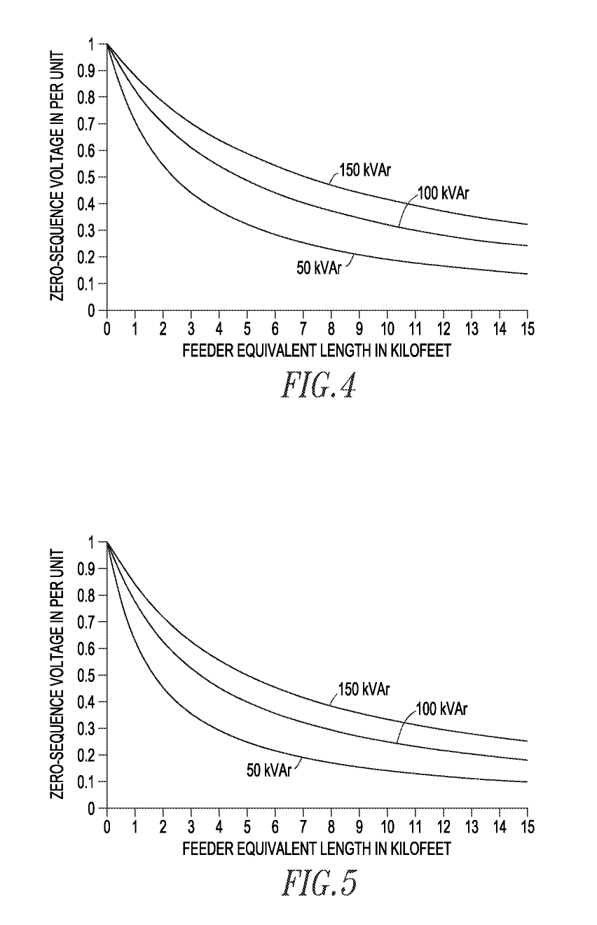

In FIG. 4, the feeder zero-sequence voltage in per unit of nominal phase-to-neutral voltage is plotted versus the total length of the primary feeder cable in kilo-feet, for three-phase cable charging at 13.2 kV of 35 kVAr per mile (FIG. 4) or 50 kVAr per mile (FIG. 5). This shows the zero-sequence voltage versus the length of the primary cable being back fed, for capacitor sizes of 50, 100 and 150 kVAr, with the primary feeder three-phase charging being 35 kVAr per mile (6.629 kVAr/kilo-foot) when there are 1000 kVA network transformers (13.2 kV, Z_{T}=5.1%, X_{T}/R_{T}=8) in the spot network. Regardless of capacitor size, with zero primary cable length, the zero-sequence voltage is 1.0 per unit.

As the length L (FIG. 1) of cable being back fed increases, the zero-sequence voltage decreases for a given capacitor size, but at any cable length increasing the capacitor size will increase the zero-sequence voltage. With the 150 kVAr capacitor, the zero-sequence voltage will exceed 0.30 per unit (30%) for feeder lengths up to 15 kilo-feet. The capacitive reactance of the example 150 kVAr, 13.8 kV capacitor is X_{C}=1269Ω. Under normal operation in a 13.2 kV system with the feeder circuit breaker 4 (FIG. 1) closed, the capacitor current, which is approximately the current seen by the feeder ground relay (not shown), is 7621/1269 (where 7621 V=13200/√3 V is the line-to-neutral voltage of a 13.2 kV line-to-line system; when the feeder circuit breaker 4 is closed, the system neutral is held at or very near ground potential and the capacitor 2 is subjected to line-to-neutral voltage) or 6.01 amperes. This would be below the pickup of any ground relay applied with the primary feeder. Should a single line-to-ground fault occur on either phase without the capacitor 2 (FIG. 1), the current drawn by the capacitor 2 would be 13,200/1269 or 10.4 amperes. Assuming that a network protector, such as 62 (FIG. 2), could fail to open during the back feed, the capacitor CL fuse would be sized to carry this current continuously. The capacitive reactance of the example 50 kVAr, 13.8 kV capacitor is X_{C}=3809Ω, and the capacitive reactance of the example 100 kVAr, 13.8 kV capacitor is X_{C}=1904 Ω.

FIG. 5 plots the same information as in FIG. 4, except that the primary feeder three-phase cable charging is 50 kVAr per mile (9.470 kVAr/kilo-foot), practically an upper bound at 13.2 kV for cable sizes up to 500 KCmil (thousand circular mil or MCM). With the example 50 kVAr shunt capacitor, the zero-sequence voltage is about 10% for 15 kilo-feet of primary cable. With the example 150 kVAr shunt capacitor, the zero-sequence voltage is about 25% for 15 kilo-feet of primary cable, and with the example 100 kVAr capacitor it is above about 18%. This level is about 9 to 10 times the zero-sequence voltage that would exist when the feeder circuit breaker 4 (FIG. 1) is closed in absence of a fault. A change of this magnitude should allow setting of the detection level of the circuit 40 of FIG. 2 such that the back feed with the feeder circuit breaker 4 can be positively detected.

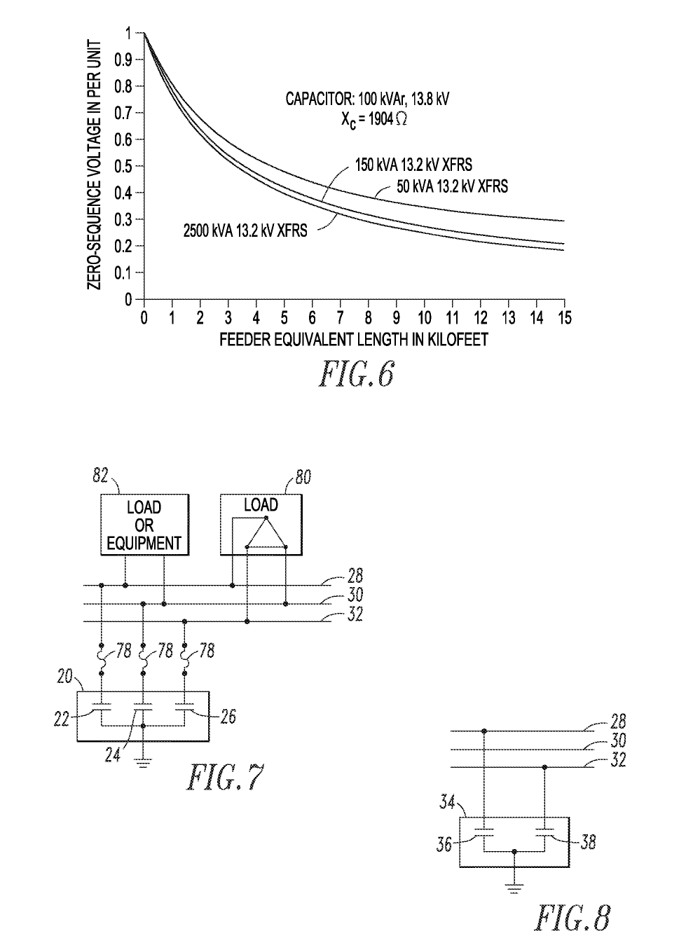

FIG. 6 shows the effect of the size of each of the two network transformers 12,16 (FIG. 1) in the spot network on the zero-sequence voltage for three different transformers sized at 50 kVA, 150 kVA and 2500 kVA, assuming an example 100 kVAr capacitor 2 (FIG. 1) on one of the three feeder phases. For the size of typical transformers used in two-unit spot networks, between 500 kVA and 2500 kVA, transformer size has a minimal effect on the zero-sequence voltage during a balanced back feed.

FIG. 7 shows the example three-phase capacitor bank 20 in which one or two of the three capacitors 22,24,26 is larger than the other capacitor(s) to create a detectable neutral shift. For example and without limitation, the capacitive reactance X_{C1},X_{C2},X_{C3} of each of the three capacitors 22,24,26 can be unequal (X_{C1}≠X_{C2} X_{C3}); the capacitive reactance X_{C2} of one 24 of the three capacitors 22,24,26 can be smaller than that of the other two capacitors (X_{C1}>X_{C2}<X_{C3}); the capacitive reactance X_{C2} of one 24 of the three capacitors 22,24,26 can be larger than that of the other two capacitors (X_{C1}<X_{C2}>X_{C3}); the capacitive reactance X_{C2} of one 24 of the three capacitors 22,24,26 can be smaller than that of the other two capacitors (X_{C2}<X_{C1}=X_{C3}); and the capacitive reactance X_{C2} of one 24 of the three capacitors 22,24,26 can be larger than that of the other two capacitors (X_{C2}>X_{C1}=X_{C3}). Although X_{C2} is used as a reference in some of these examples, either of the other two capacitive reactances can be employed for the other two phases.

FIG. 8 shows the example two-phase capacitor bank 34 in which two equal capacitors 36,38 are applied to only two 28,30 of three phases 28,30,32 to create a detectable neutral shift.

The disclosed feeder is medium voltage although the teachings of the disclosed concept can be applied to suitable low voltage or high voltage feeders.

The disclosed concept is applicable to dedicated network feeders where the network transformers have delta-connected primary windings, or non-dedicated feeders where all non-network transformers on the feeder also have the delta-connected primary windings. A dedicated network feeder, for example, supplies only network transformers, which employ ungrounded primary windings (typically delta). A non-dedicated feeder may also serve non-network loads. If the disclosed concept is being applied on a non-dedicated feeder, then any non-network three-phase load, such as 80 of FIG. 7, is electrically connected as a delta, and any single-phase load or equipment, such as 82 of FIG. 7, on the three-phase feeder is electrically connected line-to-line (not line-to-ground).

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A feeder power source for a network power system, said feeder power source comprising:
a network transformer including a delta three-phase primary winding and a three-phase secondary winding;
a three-phase primary feeder electrically connected to the delta three-phase primary winding;
a three-phase secondary bus electrically connected to the three-phase secondary winding;
a three-phase electrical switching apparatus structured to open and close the three-phase primary feeder;
a network protector including a network relay and a three-phase circuit breaker structured to open and close the three-phase secondary bus;
a first circuit electrically connected between at least one phase of the three-phase primary feeder and ground, said first circuit being structured to unbalance shunt impedance to said ground of said three-phase primary feeder; and
a second circuit structured to detect a shift in system neutral and detect that said three-phase primary feeder is opened by said three-phase electrical switching apparatus.

2. The feeder power source of claim 1 wherein said second circuit is structured to cooperate with the network relay and cause the three-phase circuit breaker to open said three-phase secondary bus.

3. The feeder power source of claim 1 wherein said first circuit is a three-phase capacitor bank.

4. The feeder power source of claim 3 wherein said three-phase capacitor bank is three capacitors; wherein each capacitor of said three capacitors is electrically connected between a corresponding phase of said three-phase primary feeder and said ground; and wherein capacitive reactance of one of said three capacitors is larger than capacitive reactance of the other two of said three capacitors.

5. The feeder power source of claim 3 wherein said three-phase capacitor bank is three capacitors; wherein each capacitor of said three capacitors is electrically connected between a corresponding phase of said three-phase primary feeder and said ground; and wherein said three capacitors are selected from the group consisting of:
a capacitive reactance of each of one or two of said three capacitors is larger than a capacitive reactance of each of a remainder of said three capacitors,
a first capacitive reactance of a first one of said three capacitors is different from a second capacitive reactance of a second one of said three capacitors and is different from a third capacitive reactance of a third one of said three capacitors,
a first capacitive reactance of a first one of said three capacitors is smaller than a second capacitive reactance of a second one of said three capacitors and is smaller than a third capacitive reactance of a third one of said three capacitors,
a first capacitive reactance of a first one of said three capacitors is larger than a second capacitive reactance of a second one of said three capacitors and is larger than a third capacitive reactance of a third one of said three capacitors,
a first capacitive reactance of a first one of said three capacitors is smaller than a second capacitive reactance of a second one of said three capacitors, said second capacitive reactance being equal to a third capacitive reactance of a third one of said three capacitors, and
a first capacitive reactance of a first one of said three capacitors is larger than a second capacitive reactance of a second one of said three capacitors, said second capacitive reactance being equal to a third capacitive reactance of a third one of said three capacitors.

6. The feeder power source of claim 1 wherein said first circuit is a single-phase capacitor bank.

7. The feeder power source of claim 6 wherein said single-phase capacitor bank is a number of capacitors electrically connected between one phase of said three-phase primary feeder and said ground.

8. The feeder power source of claim 7 wherein said number of capacitors is rated at one of 50 kVAr, 100 kVAr and 150 kVAr for a voltage of 13.8 kV.

9. The feeder power source of claim 7 wherein said three-phase primary feeder has a charging capacitance of 35 kVAr per mile or 50 kVAr per mile.

10. The feeder power source of claim 7 wherein capacitive reactance of said number of capacitors is selected from the group consisting of 1269 Ω, 1904Ω, and 3809 Ω.

11. The feeder power source of claim 1 wherein said second circuit comprises:
for three phases of said three-phase primary feeder having three voltages, a circuit to measure the three voltages,
a summation circuit to sum the three measured voltages, and
a circuit to determine if the summed three measured voltages exceeds a predetermined value for a predetermined time and responsively cause said three-phase secondary bus to be opened by said three-phase circuit breaker.

12. The feeder power source of claim 11 wherein said circuit to measure the three voltages includes a voltage division circuit for each of the three voltages.

13. The feeder power source of claim 11 wherein said circuit to measure the three voltages includes three resistance voltage dividers having an input, a ground and an output; wherein the input of each of the three resistance voltage dividers is coupled to a connector having a first terminal for a corresponding one of the three phase voltages, a second terminal for a corresponding terminal of the delta winding of said network transformer, and a third terminal electrically connected to the input of a corresponding one of the three resistance voltage dividers; and wherein said summation circuit includes three inputs, each of said three inputs being for the output of a corresponding one of the three resistance voltage dividers.

14. The feeder power source of claim 11 wherein said circuit to determine if the summed three measured voltages exceeds the predetermined value for the predetermined time includes a voltage reference to output a reference voltage as the predetermined value, a comparator to compare the summed three measured voltages to the reference voltage, and a timer to time the predetermined time when the summed three measured voltages exceed the reference voltage.

15. The feeder power source of claim 11 wherein said circuit to determine if the summed three measured voltages exceeds the predetermined value for the predetermined time includes a relay controlling a contact to cause said three-phase secondary bus to be opened by said three-phase circuit breaker independent of detection of reverse current flow by said network protector.

16. The feeder power source of claim 15 wherein said circuit to determine if the summed three measured voltages exceeds the predetermined value for the predetermined time includes a relay controlling a first normally open contact to cause said three-phase secondary bus to be opened by said three-phase circuit breaker; wherein the network relay of said network protector includes a second normally open contact to cause said three-phase secondary bus to be opened by said three-phase circuit breaker responsive to detection of reverse current flow by said network relay; and wherein said first normally open contact is electrically connected in parallel with said second normally open contact.

17. The feeder power source of claim 16 wherein the network relay of said network protector further includes a third normally open contact to cause said three-phase secondary bus to be closed by said three-phase circuit breaker; and wherein the relay controlling the first normally open contact further controls a first normally closed contact electrically connected in series with the third normally open contact in order to block the network relay from reclosing said three-phase circuit breaker.

18. The feeder power source of claim 1 wherein said first circuit is a two-phase capacitor bank; and wherein two capacitors each having the same capacitive reactance are each electrically connected between a corresponding phase of two phases of said three-phase primary feeder and ground.

19. The feeder power source of claim 1 wherein a phase-to-phase voltage of said three-phase primary feeder is a medium voltage.

20. The feeder power source of claim 1 wherein a phase-to-phase voltage of said three-phase secondary bus is a low voltage.

21. The feeder power source of claim 1 wherein said three-phase primary feeder is electrically connected between the delta three-phase primary winding and said three-phase electrical switching apparatus in order to provide a dedicated network feeder.

22. The feeder power source of claim 1 wherein said three-phase primary feeder is electrically connected between the delta three-phase primary winding and said three-phase electrical switching apparatus in order to provide a non-dedicated network feeder; wherein a non-network load is electrically connected to said three-phase primary feeder; and wherein said non-network load is a three-phase load electrically connected as a delta or a single-phase load electrically connected phase-to-phase.
